(19) United States
(12) Patent Application Publication
(10) Pub. No.: US 2010/0053468 A1
(43) Pub. Date: Mar. 4, 2010

(54) DEVICE IR SETUP USING IR DETECTOR

(76) Inventor: Mike Harvill, Orange, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,044

(22) Filed: Aug. 25, 2009

Related U.S. Application Data
(60) Provisional application No. 61/093,312, filed on Aug. 30, 2008.

(51) Int. Cl. H04N 5/44

(52) U.S. Cl. 348/734; 348/E05.096

(57) ABSTRACT

Systems and methods that allow the user to press one key on the device's remote to setup the IR codes for an AV device to be controlled by a universal remote control unit or centrally controlled by a television over IR blaster cables. In a preferred embodiment, the IR signal detection system of a television or a universal remote control unit is used to detect and learn the IR code corresponding to a single key, preferably the power key, on a remote control for the AV device to be controlled. Once the code corresponding to the key of the remote control unit pressed by the user is learned, the control system will search for a matching code in IR code tables stored in memory, which include IR code sets for different AV devices. Once a match is found, the control system will assign the corresponding code set to the AV device for future control.

### CROSS-REFERENCE TO RELATED APPLICATION

This application claims priority to provisional application Ser. No. 61/093,312 filed Aug. 30, 2008, which application is fully incorporated hereby by reference.

### FIELD

The embodiments described herein relate generally to universal remote control devices for televisions and, more particularly, to systems and methods that facilitate the set up of an input device's IR control codes using the IR detector system.

### BACKGROUND INFORMATION

Universal remotes and televisions that blast IR codes to attached devices may contain many IR device code tables. To determine which code is the right one for a device, the user has to look up the device model code in a list, or try each different code listed in the table until one works. The initial set-up or programming of a universal remote is often fraught with frustration especially when the user is not immediately successful in being able to control a particular device of interest.

Thus, it is desirable to provide systems and methods that simplify this process.

### SUMMARY

The embodiments provided herein are directed to systems and methods that simplify the set up process for universal IR remote control units and/or an IR blaster systems for a television. Instead of searching through tables for the right device code, trying the codes for all the devices until one is found that works, or learning all the commands for a device, embodiments provided herein allow the user to press one key on the device's remote, at which point the entire device control is set up.

In one embodiment, an infrared (IR) signal detection system of the television is used to detect and learn the IR code corresponding to a single key, preferably the power key, on a remote control unit for an input device connected to the television and controlled via IR commands. The power key is preferred as it is common to most if not all remote control units Once the code corresponding to the key of the remote control unit that was pressed by the user is learned, the control system of the television will search for a matching code in IR code tables stored in memory, which include IR code sets for different devices. Once a match is found, the control system will assign the code set to the input device for future control.

Preferably, as provided in the embodiments described herein, the television includes a menu-based control system capable of centrally controlling a plurality of input devices

In another embodiment, an infrared (IR) signal detection system of a universal remote control unit is used to detect and learn the IR code corresponding to a single key on a remote control unit for an input device to be controlled by the universal remote control unit. Once the code corresponding to the key of the remote control unit that was pressed by the user is learned, the control system of the universal remote will search for a matching code in IR code tables stored in memory, which include IR code sets for different devices. Once a match is found, the control system will assign the code set to the input device for future control.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television and control system.

FIG. 2 is a schematic of a universal remote control unit and a remote control unit of a device to be controlled with the universal remote control unit.

FIG. 3 is a schematic showing a process followed to learn device IR codes when a new device is coupled to the television.

FIG. 4 is a schematic showing a process followed to learn device IR codes.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein are directed to remote control units and a simplified process for setting up the IR control codes for input devices connected to and to be centrally controlled by the television or controlled by a universal remote control unit. As discussed in detail below, in one embodiment, the control system of a television or a universal remote control unit will automatically learn the IR control commands of an audio-video (AV) device, such as a television, an AV receiver, a DVD, and the like, that is coupled to and to be centrally controlled by a television or controlled by the universal remote control unit. More particularly, the control system will automatically learn the IR control commands of the input device by detecting and learning the IR code corresponding to a single key, preferably the power on/off key, of a remote control unit for the AV device. Once the code corresponding to a particular key such as the power key of the remote control unit for the AV device is learned, the control system will search for a matching code in IR code tables stored in memory. The IR code tables include IR code sets for different IR controlled AV devices. Once a match is found, the control system will assign the code set to the AV device for future control, i.e., link the code set in the control system of the universal remote to a device selection key selection or link the code set to a device selection in a device selection menu of the television control system.

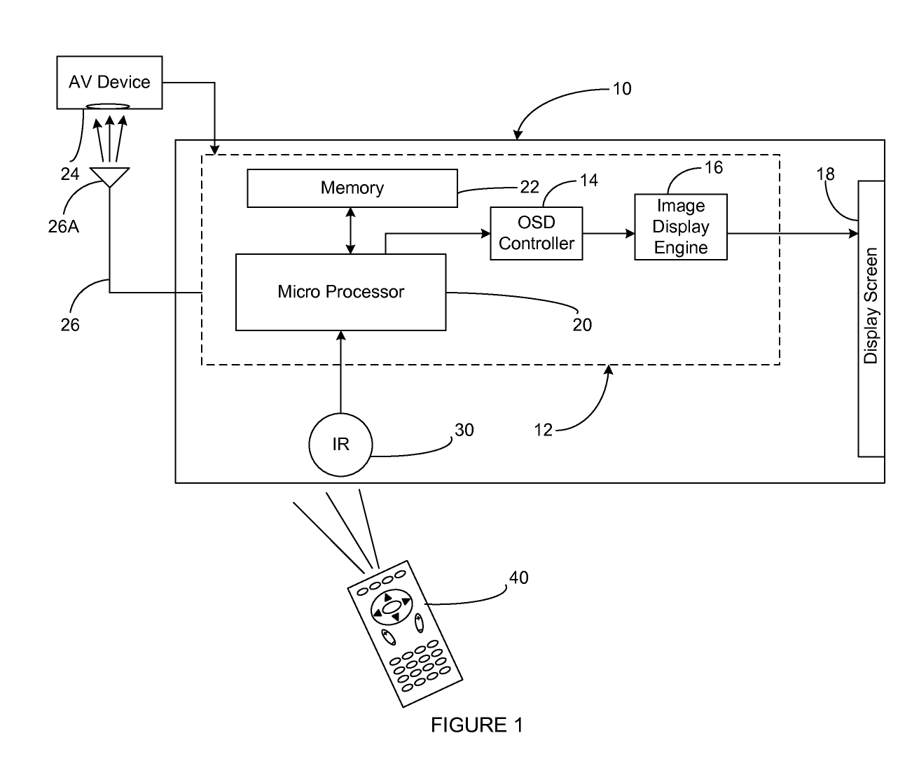

Turning in detail to the figures, FIG. 1 depicts a schematic of an embodiment of a television 10. The television 10 preferably comprises a video display screen 18 and an IR signal receiver or detection system 30 coupled to a control system 12 and adapted to receive, detect and process IR signals received from a remote control unit 40. The control system 12 preferably includes a micro processor 20 and non-volatile memory 22 upon which system software is stored along with IR code tables containing IR codes for a plurality of devices, an on screen display (OSD) controller 14 coupled to the micro processor 20, and an image display engine 16 coupled to the OSD controller 14 and the display screen 18. The system software preferably comprises a set of instructions that are executable on the micro processor 20 to enable the setup, operation and control of the television 10. The system software provides a menu-based control system that is navigatable by the user through a graphical user interface displayed or presented to the user on the television display 18. While on the television layer of the television remote control unit, the user can navigate the graphical user interface to setup, operate and control the television 10 and external A-V input devices, such as, e.g., a DVD, a VCR, a cable box, and the like, coupled to the television 10. A detailed discussion of a graphical user interface-based menu control system and its operation is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface.

As depicted, an input AV device 24, such as a DVD, VCR, STB, or the like, is coupled to the television 10. An IR blaster cable 26 with an IR emitter or transmitter 26A coupled to the AV device end of the blaster cable 26, is shown operably coupling the control system 12 of the television 10 to the AV device 24 to transmit IR code signals to the AV device 24 from the control system 12.

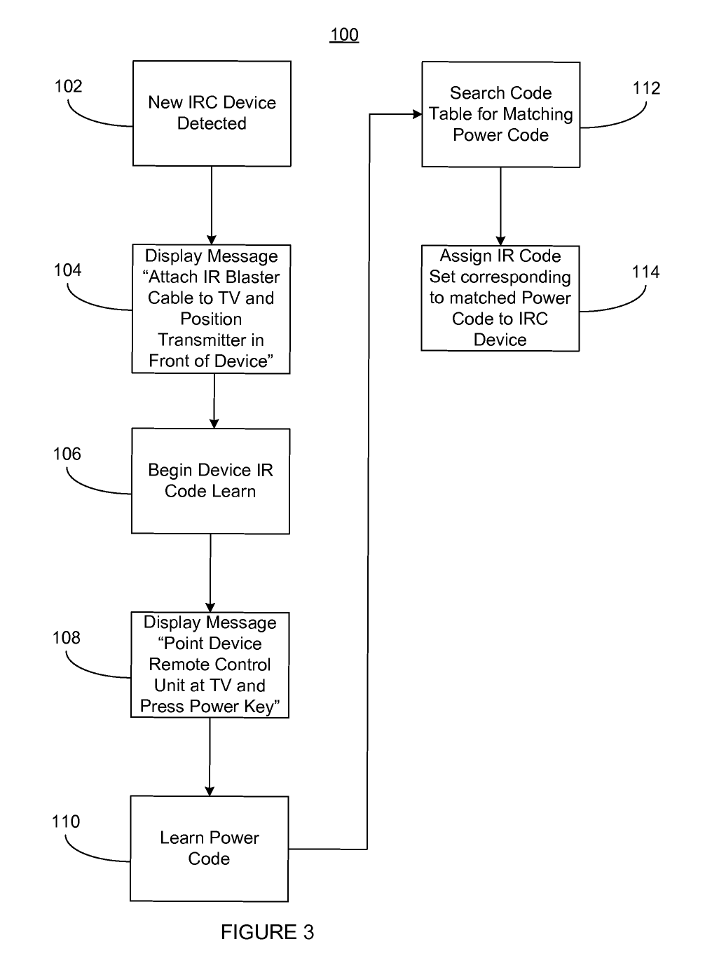

Turning to FIG. 3, in a depicted plug-and-play mode 100, the control system will detect at step 102 the presence of a new input device connected to the television 10. At step 104, the control system will display a message on the screen instructing or prompting the user to attach an IR blaster cable to television and position the IR emitter or transmitter 26A on the end of the IR blaster cable 26 in front of the input device. Next, at step 106, the control system will begin the process to learn the IR codes for the newly connected input device. At step 108, a setup subsystem will display a message instructing the user to point the input device's remote control unit at the television and press a key on the remote control unit. Although the process of learning the input device's IR command codes can be accomplished if any key is pressed, it is preferable to instruct the user to press a particular key, such as the power key, to reduce time and processing power needed to search the IR code tables for a match within the IR code tables to the learned IR code.

At step 110, the IR code corresponding to the key pressed on the remote control unit is detected (received) by the IR detector system of television. The television characterizes the corresponding waveform and, thus, learns the IR code corresponding to the pressed key. The setup subsystem will then search the code tables stored in memory for a matching code at step 112. The code tables include code sets for different IR controlled AV devices. Once a match is found, the code set corresponding to the matched code is assigned at step 114 within the control system to the newly connected input device to control the input device from the TV layer of the remote control unit. As discussed in the '624 application, the control system of the TV received IR codes from the remote on the TV layer and converts or translates the instruction embedded in the IR codes to input AV device specific codes and then transmits the input AV device specific codes to the input AV devices.

Since most codes are specific to a manufacturer and device type, additional information such as device type and manufacturer can be inferred from the match and used by the setup subsystem. Thus, as an alternative, once a match is found, the setup subsystem will display a verification screen indicating that a remote control unit for a particular AV device was detected and ask the user to verify the detected AV device remote control unit is correct. If the user indicates it is not the correct AV device, the system will continue to search for another match until the correct device is detected. The process can either time out after a predetermined number of unsuccessful iterations or allow the user to choose whether to restart the process or accept the detected device indicated by the verification screen.

As another alternative, the learning process can be initiated by a menu selection within the menu based control system or by pressing a dedicated key on the remote control unit of the television.

As a further alternative, the IR codes can be transmitted from the television to the AV device to be controlled over IR blaster cables or wirelessly to a wireless receiver based IR blaster modules operably coupled to the IR receiver of the AV device.

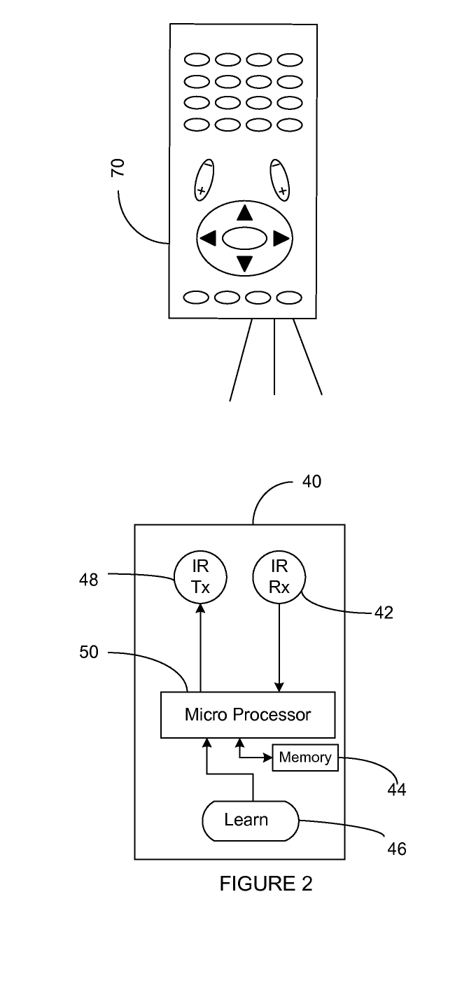

Turning to FIG. 2, a universal remote control unit 40 preferably includes an IR receiver 42 and an IR transmitter 48 coupled to a micro processor 50. Non-volatile memory 44 is coupled to the micro processor 50 and includes software stored therein to control and operate the remote control unit 40 and learn the IR codes of AV devises. The software includes a set of instructions executable on the micro processor 50. In addition, the remote control unit 40 includes a dedicated function key 46 preferably labeled “learn” coupled to the micro processor 50, which when depressed causes the micro processor 50 to initiate the IR code learning process.

The instructions for the universal remote control unit 40 preferably instructs the user to press the “learn” key 46 on the universal remote control unit 40 and then point the AV device remote control unit 70 at the IR receiver 42 of the universal remote control unit 40 as depicted in FIG. 2 and press a key, preferably the power key, on the remote control unit 40.

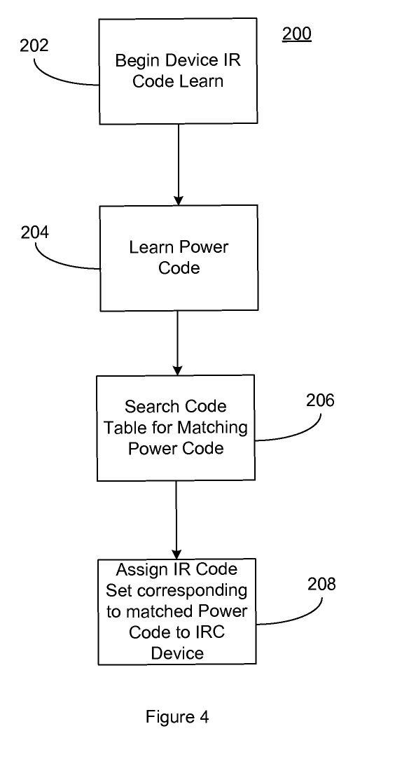

Turning to FIG. 4, a process 200 is depicted in which the IR code corresponding to a key pressed on the remote control unit 70 is detected and learned by the IR detector system of the universal remote control unit 40, which includes the receiver 42, microprocessor 50 and software stored in memory 44. The process 200 is initiated at step 202 preferably by pressing a dedicated button on the remote control unit 40 or, in the alternative, could be initiated by selecting a menu item in a user interface displayable by the control system on a screen of the remote. The control system of the remote control unit 40 will then search the code tables stored in memory 44 for a matching code at step 204. The code tables include code sets for different IR controlled AV devices. Once a match is found, the code set corresponding to the matched code is assigned at step 208 within the control system to the AV device to be controlled when a device key assigned to the device is selected on the universal remote control unit 40.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A process for learning the IR control codes for an audio-video (AV) device comprising the steps of
detecting and learning an IR code corresponding to a key on a remote control unit for an AV device to be controlled,
searching for an IR code listed in a table that matches the code corresponding to the key on the AV device remote control unit, and
assigning a set of IR codes corresponding to a matched code to the AV device within a control system to be used to control the AV device.

2. The process of claim 1 further comprising the step of verifying if the matched code corresponds to the AV device to be controlled.

3. The process of claim 2 further comprising the step of prompting a user to press a key on the remote control unit of the AV device.

4. The process of claim 3 wherein the step of prompting a user to press a key on the remote control unit of the AV device includes prompting the user to press a predetermined key.

5. The process of claim 4 wherein the predetermined key is a power key.

6. A process for learning the IR control codes for an audio-video (AV) device coupled to a television and controllable by the television with IR codes transmitted to the device over IR blaster cables comprising the steps of
prompting a user to point a remote control unit of an AV device to be controlled at an IR receiver of the television and press a key on the remote control device,
detecting and learning an IR code corresponding to the key on the remote control unit pressed by the user,
searching for an IR code listed in a table that matches the code corresponding to the key pressed on the remote control unit, and
assigning a set of IR codes corresponding to a matched code to the AV device within a control system of the television to be used to control the AV device.

7. The process of claim 6 further comprising the step of verifying if the matched code corresponds to the AV device to be controlled.

8. The process of claim 7 wherein the verifying step includes the displaying a verification screen indicating the AV device corresponding to the detected code and prompting the user to confirm whether the indicated device is correct.

9. The process of claim 8 further comprising the step of prompting a user to connect an IR blaster cable to an output port on the television and operably couple the IR blaster cable to the AV device to be controlled.

10. The process of claim 9 further comprising the step of auto detecting an AV device to be controlled when coupled to the television.

11. The process of claim 10 wherein the step of prompting a user to press a key on the remote control unit of the AV device includes prompting the user to press a predetermined key.

12. The process of claim 11 wherein the predetermined key is a power key.

13. A process for learning the IR control codes for an audio-video (AV) device to be controlled by a universal remote control unit comprising the steps of
detecting and learning an IR code corresponding to the key on the remote control unit pressed by the user using an IR detection system of the universal remote control unit,
searching for an IR code listed in a table stored in memory of the universal remote control unit that matches the code corresponding to the key pressed on the AV devices remote control unit, and
assigning a set of IR codes corresponding to a matched code to the AV device within a control system of the universal remote control unit.

14. The process of claim 1 wherein the step of learning the IR code include characterizing the wave form of a received IR signal to determine the IR code in the signal.

15. The process of claim 6 wherein the step of learning the IR code include characterizing the wave form of a received IR signal to determine the IR code in the signal.

16. The process of claim 13 wherein the step of learning the IR code include characterizing the wave form of a received IR signal to determine the IR code in the signal.
